(19) United States
(12) Patent Application Publication
(10) Pub. No.: US 2019/0048231 A1
(43) Pub. Date: Feb. 14, 2019

(54) MAKING ADHESIVE SILICONE SUBSTANCES ADHERE TO FLUOROPOLYMER FILMS USING A CORONA TREATMENT

(71) Applicant: TESA SE, NORDERSTEDT (DE)

(72) Inventors: Stephan BERNT, Hamburg (DE); Marcel HÄHNEL, Klein Nordende (DE)

(73) Assignee: TESA SE, NORDERSTEDT (DE)

(21) Appl. No.: 16/076,884

(22) PCT Filed: Feb. 16, 2017
(86) PCT No.: PCT/EP2017/053494

§ 371 Date: Aug. 9, 2018

(30) Foreign Application Priority Data
Feb. 17, 2016 (DE) 10 2016 202 396.9

(51) Int. Cl. C09J 5/02; C09J 7/24; C09J 183/04; B05D 1/40; B05D 3/14; B05D 3/00; B05D 5/10; B05D 7/04; B29C 33/68

(52) U.S. Cl. CPC C09J 5/02; C09J 7/24; C09J 183/04; B05D 1/40; B05D 3/144; C09J 2483/00; B05D 5/10; B05D 7/04; B29C 33/68; C09J 2205/31; C09J 2427/006; B05D 3/007

(57) ABSTRACT

Method for manufacturing an adhesive film wherein one entire face of a fluoropolymer film is activated with a plasma, an adhesive silicone substance is immediately applied to the entire activated face, and the applied silicone substance is cross-linked.

This is a 371 of PCT/EP2017/053494 filed 16 Feb. 2017, which claims foreign priority benefit under 35 U.S.C. 119 of German Patent Application 10 2016 202 396.9 filed Feb. 17, 2016, the entire contents of which are incorporated herein by reference.

The invention relates to a method for the production of an adhesive film and a production method for a fiber composite material.

### BACKGROUND OF THE INVENTION

The adhesive tape according to the invention is intended in particular to be suitable for lining molds in composite construction, e.g. molds used in lamination methods for fiber composite materials. In this case, the inner surfaces of the molds are completely masked with the adhesive tape. The adhesive tape composed of a carrier film and an adhesive substance layer should show favorable antiadhesive properties so that the cured laminate can be easily removed from the mold and the mold masked with the adhesive tape can then immediately be supplied to a further production cycle.

A method is known from WO 2015/014646 for molding a body in a mold in which an adhesive tape is applied to an inner surface of a mold, laminate layers on the inner surface of the mold are applied to the adhesive tape, the laminate layers are infused with an epoxy resin and cured, and the laminate component can easily be detached from the adhesive tape after curing. For this purpose, a carrier film of the adhesive tape comprises fluoropolymers. Fluoropolymers are generally known for their favorable antiadhesive properties. An adhesive substance layer is applied to the carrier film. In this case, the layer may be a silicone adhesive substance layer. The adhesive substances are directly applied to the carrier film and then crosslinked by means of thermal treatment or UV light irradiation. The adhesive tape can then be rolled up and later provided for its intended use. Disadvantageously, it has been found that the separating forces between the silicone adhesive substance and the fluoropolymer film are not sufficiently strong, as the fluoropolymer film also exerts its favorable antiadhesive properties with respect to the silicone adhesive substance and the adhesive tape may therefore be destroyed after the laminate component is removed from the mold.

CN 103421200 discloses a method by which the separating forces between the fluoropolymer film and an adhesive substance layer can be increased, wherein the fluoropolymer film is treated exclusively in the form of PTFE by means of organic solvents in an ultrasound bath. For this purpose, the PTFE film is washed in methanol/ethanol/isopropanol/acetone or in toluene. The purified surface is subjected to plasma treatment. The plasma used in CN 103421200 is produced only in highly pure noble gases and under extremely narrow physical parameters, such as current, density, and voltage. This plasma process cannot be implemented on an industrial basis, and the limiting factors are described in detail in CN 103421200:
Process gas: argon at 10-25 l/min
Voltage: 9-12 kV @ 10-20 kHz
Current density: 0.5-2 mA/cm²
Oxygen content: 0.01-2%
Duration of plasma treatment: 15-60 s

The method according to CN 103421200 is not suitable for activation of substances other than PTFE, because impurities such as “weak layers” cannot be removed and therefore adversely affect the adhesive bond with the adhesive substance.

The object of the invention is therefore to provide both a method for the production of an adhesive film and an improved method for the production of fiber composite materials.

The object is achieved in its first aspect by means of an above-mentioned method with the features of claim 1. Preferred improvements of the invention are the subject matter of the dependent claims.

### SUMMARY OF THE INVENTION

In order to improve the adhesion properties of the silicone adhesive substance layer on the fluoropolymer film, one side of the fluoropolymer film, to which the silicone adhesive substance layer is applied, is pretreated. The pretreatment strengthens the intermolecular forces between the fluoropolymer film and the silicone adhesive substance layer.

### DETAILED DESCRIPTION

According to the invention, this pretreatment is carried out by a physical method such as plasma or corona treatment. Plasma is also referred to as the fourth aggregate state of matter. It is a partially or completely ionized gas. As a result of the energy supplied, positive and negative ions, electrons, other aggregate states, electromagnetic radiation, and chemical reaction products are produced. Many of these species can lead to changes in the surface to be treated, here the surface of the fluoropolymer film. In summary, the treatment results in activation of the fluoropolymer film surface, specifically to higher reactivity. The treatment is used according to the invention in order to increase the separating force between the fluoropolymer film surface and the silicone adhesive substance layer.

Corona treatment, also referred to as corona discharge, takes place as a high-voltage discharge with direct contact with the fluoropolymer film surface.

The discharge causes molecules of the ambient air or ambient air enriched with said molecules, preferably nitrogen, to be converted into reactive form. The impact of the incident electrons causes molecules on the fluoropolymer film surface to split. In particular, fluorine atoms can be removed from the fluoropolymer surface. The resulting free valences allow accumulation of the reaction products of the corona discharge. This accumulation allows the adhesion properties of the fluoropolymer film surface to be improved.

As corona treatment is known to show limited stability over time with respect to activation of the fluoropolymer film surface, the silicone adhesive substance should be glued onto the fluoropolymer film surface soon or usually immediately after activation. The silicone adhesive substance is preferably applied within a short period, preferably less than 2 hours after activation of the fluoropolymer film surface.

For example, plasma and corona pretreatments have been previously described or mentioned in DE 2005027391 A1 and DE 10347025 A1.

DE 102007063021 A1 describes activation of adhesive substances by means of a filamentous corona treatment. It is disclosed that the prior plasma/corona pretreatment has a positive effect on the shear life and flow behavior of the adhesive bond. It was not found that the method can produce an increase in adhesive strength.

Similarly to DE 102007063 021 A1, DE 102011075470 A1 describes the physical pretreatment of an adhesive substance and a carrier/substrate. The pretreatments are carried out separately prior to the joining step and can be configured to be either the same or different. This two-sided pretreatment allows greater adhesive and anchoring forces to be achieved than in substrate-side pretreatment.

The invention combines two contradictory requirements placed on the adhesive film. The adhesive film must show highly favorable antiadhesive properties on one of its outer surfaces, but favorable adhesive properties on its other outer surface. The adhesive film comprises a fluoropolymer film or layer and a silicone adhesive substance layer.

On the one hand, the fluoropolymer film is used as the outer surface of the adhesive film so that fiber composite materials adhering to it can be easily detached from the adhesive film after a lamination process. On the other hand, the silicone adhesive substance layer opposite the laminate must adhere to the other side of the fluoropolymer film with a particularly strong separating force. The invention solves the problem of these requirements for the properties of the fluoropolymer film, which are contradictory per se, in that the other side of the fluoropolymer film is subjected to corona treatment before the silicone adhesive substance layer is applied.

By means of the corona treatment as a kind of physical pretreatment of the surface, the surface properties of the other side of the fluoropolymer film are altered. This change increases the separating force of the silicone adhesive substance layer on the other side of the fluoropolymer film.

The physical pretreatment of substrates (such as flame, corona, or plasma treatment) in order to improve adhesive strength is common primarily for liquid reactive adhesives. In this case, an object of the physical pretreatment can also be fine purification of the substrate, for example of oils, or an application in order to enlarge the effective area.

In physical pretreatment, one speaks of “activation” of the surface. This usually implies a non-specific interaction, in contrast for example to a chemical reaction according to the lock-and-key principle. Activation usually implies an improvement in the wettability, printability or anchoring of a coating.

In self-adhesive tapes, a bonding agent is commonly applied to the substrate. This step is often prone to failure, complex, and must be carried out manually.

The success of improvement in the adhesion of adhesive substances by physical pretreatment of the substrate (flame, corona, plasma) is not universal, as non-polar adhesive substances, such as natural or synthetic rubber, typically benefit little from such treatment.

Corona treatment is defined as a surface treatment with filamentous discharges produced by high alternating voltage between two electrodes, wherein the discrete discharge channels are incident on the surface to be treated, also cf. Wagner et al., Vacuum, 71 (2003), pp. 417 to 436.

In particular, in industrial applications, the term corona is understood to refer to a dielectric barrier discharge (DBD). In this case, at least one of the electrodes is composed of a dielectric, i.e. an insulator, or is coated or covered with such a dielectric. In this case, the substrate can also function as a dielectric.

The intensity of a corona treatment is indicated as a “dose” in [Wmin/m²], where dose D=P/b*v, P=electric power [W], b=electrode width [m], and v=web speed [m/min].

The substrate is almost always placed or guided in the discharge space between an electrode and a counterelectrode, which is defined as “direct” physical treatment. In this case, substrates in web form are typically guided between one electrode and a second electrode that can be figured as a roller, preferably in a grounded state.

The term “film” is understood to refer to a flexible object that extends in the directions of length and width. This object has a thickness running perpendicularly to the two directions, wherein the width direction and length direction are many times larger than the thickness. The thickness of the film is the same over the entire area of the film determined by length and width, and preferably exactly the same.

The film is bounded along its entire area determined by its extension in length and width. The area can be of virtually any desired configuration.

However, the film is preferably in web form. The term “web” is understood to refer to an object whose length is many times greater than its width and whose width is preferably configured to remain almost exactly the same along the entire length.

The film can be stored rolled on a roll, in particular as a web, and can be transported and brought to the application site as a roll.

In particular, it can be trimmed at said site in such a way that an infusion mold can be configured for the production of a laminate part.

Particularly preferably, a film is used as a carrier film that comprises one or at least two fluoropolymers.

Fluoropolymers or fluorinated polymers are understood in the context of this invention, and in general, to refer both to fluorinated polymers composed exclusively of carbon atoms and to those with heteroatoms in the main chain.

Representatives of the former group are homo- and copolymers of olefinically unsaturated fluorinated monomers.

The fluoropolymers resulting from these monomers are divided into the categories of polytetrafluoroethylene, fluorothermoplastics, fluororubbers and the fluoroelastomers obtained therefrom by vulcanization. The most important representatives of the fluoropolymers with heteroatoms in the main chain are the polyfluorosiloxanes and polyfluoroalkoxyphosphazenes.

Preferably, the carrier film comprises one or at least two fluoropolymers to 50 wt %, more preferably 75 wt %, particularly preferably 90 wt %, and most particularly preferably 95 wt % (based in each case on the total composition of the carrier film).

More preferably, the polymers forming the carrier film are composed to 100 wt % of one or at least two fluoropolymers. The fluoropolymers can also optionally be added to the additives described below. The latter—as mentioned—are not absolutely required, and need not be used.

In particular, PTFE (polytetrafluoroethylene), ETFE (poly(ethylene-co-tetrafluoroethylene)), FEP (poly(tetrafluoroethylene-co-hexafluoropropylene)), PVDF (poly(1,1-difluoroethene) or PFA (perfluoroalkoxy polymers) are suitable as fluoropolymers, or mixtures of two or more of the above-mentioned fluoropolymers.

PTFE refers to fluoropolymers that are composed of tetrafluoroethene monomers.

ETFE is a fluorinated copolymer composed of the monomers chlorotrifluoroethylene, or also tetrafluoroethylene and ethylene.

FEP, also called fluorinated ethylene-propylene copolymer, refers to copolymers of tetrafluoroethene and hexafluoropropene.

PVF is a polymer produced from vinyl fluoride (polyvinyl fluoride).

PCTFE is a polymer composed of chlorotrifluoroethylene (polychlorotrifluoroethylene).

ECTFE is a copolymer composed of ethylene and chlorotrifluoroethylene.

PVDF refers to fluoropolymers producible from 1,1-difluoroethene (vinylidene fluoride).

PFA refers to copolymers with groupings such as

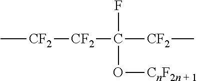

as basic units [poly(tetrafluoroethylene-co-perfluoroalkyl vinyl ether)]. PFAs result from the copolymerization of tetrafluoroethene and perfluoroalkoxy vinyl ethers (such as perfluorovinyl propyl ether, n=3).

The fluoropolymers can be mixed with further polymers, wherein the fluoropolymers must show good miscibility with the other polymers.

Suitable polymers are olefinic polymers such as homo- or copolymers of olefins such as ethylene, propylene or butylene (here, the term copolymer is to be understood analogously as including terpolymers), polypropylene homopolymers or polypropylene copolymers, including the block (impact) and random polymers.

Further polymers, used alone or in a mixture, can be selected from the group of the polyesters, such as in particular polyethylene terephthalate (PET), polyamide, polyurethane, polyoxymethylene, polyvinylchloride (PVC), polyethylene naphthalate (PEN), ethylene vinyl alcohol (EVOH), polyvinylidene chloride (PVDC), polyvinylidene fluoride (PVDF), polyacrylonitrile (PAN), polycarbonate (PC), polyamide (PA), sulfone (PES), polyimide (PI), polyarylene sulfide and/or polyarylene oxide.

The polymers for forming the carrier film can be present in pure form or in blends with additives such as antioxidants, light stabilizers, antiblocking agents, lubrication and processing aids, fillers, dyes, pigments and blowing or nucleating agents.

Preferably, the film comprises none of the aforementioned additives, with the exception of dyes. Dyes are preferably used, but need not necessarily be present.

During the corona treatment of the fluoropolymer surface, atoms or molecules in particular are removed from the surface of the fluoropolymer film, and the resulting free valences allow accumulation of the reaction products of the corona discharge. The reaction products depend on the process gas used. Air is preferably used as a process gas, so that the reaction product of the corona discharge will in particular be ionized oxygen, which accumulates on the fluoropolymer film surface and causes the silicone adhesive substance to accumulate on the fluoropolymer film surface with better adhesion properties.

Varying the process gas allows different functional groups to be formed at the free valences of the fluoropolymer film surface, and depending on the adhesive substance to be applied, this can lead to an increase in the separating force between the silicone adhesive substance layer and the fluoropolymer film surface. In a particularly suitable embodiment of the method according to the invention, the process gas contains a noble gas in an amount of up to 95% by volume, with the remaining 5% by volume being air. Noble gases are advantageous because higher average energies are present in the distribution of electron energy in this case. Moreover, noble metal plasmas can form energy-rich metastable species, which also leads to a larger number of functional groups on a surface to be treated.

Moreover, it is conceivable to mix hydrogen ammonia, siloxanes and hydrocarbon-containing gases into the process gas, regardless of whether the main component of the process gas is air, nitrogen, carbon dioxide or noble gases. Depending on the fluoropolymer film used, various admixtures result in particularly strong activation of the surface. The silicone adhesive substance layer applied to the activated fluoropolymer film surface can consist of one-, two-, or multicomponent adhesive systems. In a favorable embodiment of the invention, application is carried out using a peeling bar, under which the fluoropolymer film with a viscous silicone adhesive substance applied to it is pulled with a constant vertical distance, so that the silicone adhesive substance is distributed with a constant height on the surface of the fluoropolymer film. This method is advantageously suitable for applying a silicone adhesive substance layer over the entire surface of the fluoropolymer film of constant thickness, wherein the method can be carried out in a particularly simple manner, and thus with little maintenance and expense.

The silicone adhesive substance applied to the fluoropolymer film surface is then advantageously dried. Drying is carried out for example by automatic evaporation of solvents from the silicone adhesive substance.

However, other drying methods are also conceivable, for example by heating the silicone adhesive substance, and the dried silicone adhesive substance can then advantageously be crosslinked. The crosslinking is advantageously carried out by heating the silicone adhesive substance to temperatures of up to 300° C., but preferably less than 200° C.

After crosslinking of the silicone adhesive substance, a permanently tacky silicone adhesive substance is produced that adheres to the fluoropolymer surface with high separating force, so that the adhesive tape formed by the crosslinked silicone adhesive substance and the fluoropolymer film can be used for its intended application, in particular for adhesion to production molds of laminates.

The fluoropolymer film preferably has a constant thickness over the entire width and length of the film of 300 μm, preferably less than 100 μm, and the film can have a width of 1 to 2 m and basically be of unlimited length. The adhesive tape is provided as a roll, and even when the adhesive tape is rolled up, it is easy to subsequently unroll it, because the separating force between the untreated outer surface of the fluoropolymer film and the free side of the silicone adhesive substance that comes into contact with said outer surface when it is rolled up is low.

In its second aspect, the invention uses the idea of taking a fluoropolymer film having highly favorable antiadhesive properties as a carrier film for a novel production method of fiber composite materials. For this purpose, the favorable antiadhesive properties of the fluoropolymer film are taken advantage of to line a mold for producing a fiber composite material.

In this case, an application surface inner wall of the production mold, on which the fiber composite material to be subsequently produced lies, is preferably completely lined. The adhesive film according to the invention is trimmed such that the individual sections are preferably positioned edge to edge adjacent to one another and completely cover the application surface. The sections are glued with their adhesive layer directly to the application surface and pressed against it. Before this is carried out, a preferably present protective film can be peeled off the adhesive layer.

Predetermined layers, in particular woven fabric layers, carbon fiber layers, etc. are then placed on the production mold configured with a single layer of the adhesive film for the respective intended application.

The stack of layers is sealed onto the application surface by means of a vacuum film laid over the stack, and a vacuum is produced in the stack by means of inlet and outlet openings in the vacuum film through which a resin, preferably an epoxy resin, is infused. The resin is cured independently, but preferably by application of additional heat.

However, the adhesive film according to the invention advantageously makes it possible to easily remove layers directly applied to the fluoropolymer layer and infused with resin, because they have favorable antiadhesive properties.

The production mold, which is lined with the trimmed adhesive film, is advantageously used immediately in the following step of the production method for infusion of the next fiber composite material.

### BRIEF DESCRIPTION OF THE DRAWINGS

The invention is described by means of an example with figures. The figures are as follows:

FIG. 1 is a schematic diagram of a process sequence for the production of an adhesive tape according to the invention, and

FIG. 2 is a schematic diagram of a T peel test.

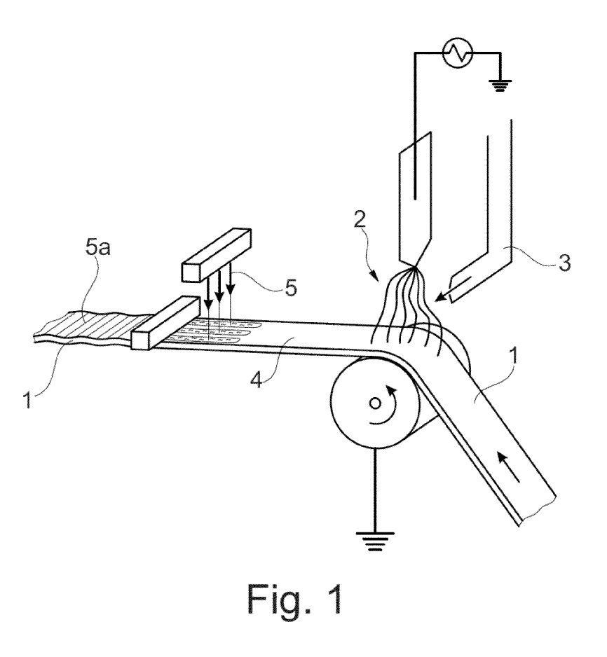

ETFE film that was provided in strip form and in an indeterminate length is used as the fluoropolymer film 1. The fluoropolymer film 1 is subjected to a filamentous corona treatment. In this case, the filamentous corona discharge is produced using a device from the firm Vetaphone. Air, nitrogen or carbon dioxide is used as a process gas 3. The process gas 3 is blown in the area of the corona discharge onto a surface of the fluoropolymer film 1 according to FIG. 1. The fluoropolymer film 1 is moved through a corona discharge filled with the process gas 3 at a speed of 50 m/min. The dose of the discharge is changed in multiple tests, and tests are also conducted with a dose of 100 Wmin/m².

The process gas 3 used is air in one test, nitrogen in a second test, and carbon dioxide in a third test. After activation of the fluoropolymer film surface by the filamentous corona discharge 2, the activated surface 4 is provided with a two-component silicone adhesive substance 5 in a second method step. The adhesive substance Dow Corning 7657 with Syl-Off 4000 as a second component is used as the silicone adhesive substance 5. According to the section on application of the silicone adhesive substance 5 to the surface of the fluoropolymer film 1, a spreading bar 6 is provided above the fluoropolymer film 1 that distributes the silicone adhesive substance 5 onto a layer with a thickness of 50 g/m². This gives rise to a silicone adhesive substance layer thickness of less than 100 μm.

A silicone adhesive substance layer 5a is then crosslinked by thermal heating, and for this purpose, the silicone adhesive substance layer 5a applied to the fluoropolymer film 1 is heat-treated at 100° C. for 2 min. Here, the fluoropolymer film 1 serves as a carrier film for the crosslinked silicone adhesive substance layer 5a, and together with said layer, forms an adhesive tape 7.

The following Table 1 shows peel forces for various process gases at a dose of 100 Wmin/m². The peel forces are also referred to as separating forces.

Peel Force after Spreading and Crosslinking on Treated Film:

Complete Cohesive Failure of all Samples

TABLE 1

| | | | | N₂ + ⅓ Ar |
|---|---|---|---|---|
| Dose/gas | Air [N/cm] | N₂ [N/cm] | CO₂ [N/cm] | [N/cm] |
| 66 Wmin/m² | | | | |
| 100 Wmin/m² | 7.27 (0.16) | 7.17 (0.03) | 7.25 (0.11) | — |
| 150 Wmin/m² | | | | — |

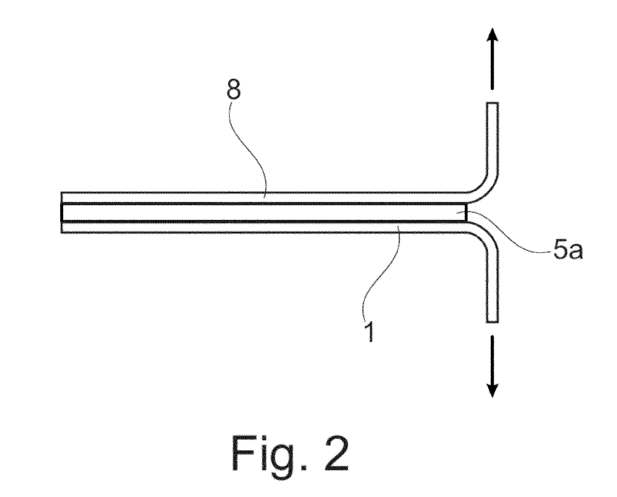

The peel forces are determined using a so-called T peel test according to FIG. 2. In this case, the adhesive tape 7 is glued onto a chemically etched polyester film 8, wherein the silicone adhesive substance layer 5a of the adhesive tape 7 is glued onto the polyester film 8. The polyester used here is PET. The test piece produced in this manner is then stored for 3 days at room temperature. The polyester film 8 and the fluoropolymer film 1 are then peeled off each other in opposite directions, resulting in an approximately T-shaped configuration of the adhesive tape during the peeling process according to FIG. 2, and the polyester film 8 and the fluoropolymer film 1 are pulled apart using a T peel machine that is set to a constant speed and measures the force required to maintain this constant speed.

The results are shown in Table 1. It can be seen that the strongest force is generated in use of air as a process gas, the second-strongest force is generated in use of carbon dioxide as a process gas, and the weakest separating force is generated in use of nitrogen as a process gas.

It is significant in all three of the tests that all three samples cohesively fail, i.e., in all three samples, the adhesive tape 7 separates when the silicone adhesive substance layer 5a fails. The result in particular is that an increase in separating force by means of an improvement, for example by changing the corona treatment, cannot have any additional effect. The separating force cannot be increased in this manner, because failure takes place inside the silicone adhesive substance layer 5a before any such increase can occur.

### LIST OF REFERENCE NOS

1. Fluoropolymer film
2. Corona discharge
3. Process gas
4. Activated surface
5. Silicone adhesive substance
5a. Silicone adhesive substance layer
6. Spreading bar
7. Adhesive tape
8. Polyester film

1. A method for the production of an adhesive film wherein one entire side of a fluoropolymer film is activated with a plasma, a silicone adhesive substance is immediately applied to the entire activated side, and the applied silicone adhesive substance is crosslinked.

2. The method as claimed in claim 1, wherein the fluoropolymer film is activated by plasma discharge.

3. The method as claimed in claim 1, wherein the silicone adhesive substance is crosslinked by the effect of temperature, electron beams, ultraviolet radiation or moisture.

4. The method as claimed in claim 1, wherein the plasma treatment takes place at less than 300° C.

5. The method as claimed in claim 1, wherein the silicone adhesive substance is applied by spreading.

6. The method as claimed in claim 1, wherein the thermal crosslinking is carried out at temperatures of less than 300° C.

7. The as claimed in claim 1, wherein a process gas selected from the group consisting of air, nitrogen, carbon dioxide and mixtures thereof is used for plasma treatment.

8. The method as claimed in claim 1, wherein PTFE (polytetrafluoroethylene), ETFE (poly(co-tetrafluoroethylene)), FEP (poly(tetrafluoroethylene-co-hexafluoropropylene)), PVF (polyvinyl fluoride), PCTFE (polychlorotrifluoroethylene), ECTFE (poly(ethylene-co-chlorotrifluoroethylene)), PVDF (poly(1,1-difluoroethene)), PFA (perfluoroalkoxy polymers) or mixtures of two or more of the above-mentioned fluoropolymers are used as fluoropolymers.

9. The method as claimed in claim 8, wherein the fluoropolymers are mixed with further polymers selected from the group consisting of polyethylene terephthalate (PET), polyamide, polyurethane, polyoxymethylene, polyvinylchloride (PVC), polyethylene naphthalate (PEN), ethylene vinyl alcohol (EVOH), polyvinylidene chloride (PVDC), polyvinylidene fluoride (PVDF), polyacrylonitrile (PAN), polycarbonate (PC), polyamide (PA), sulfone (PES), polyimide (PI), polyarylene sulfide, polyarylene oxide, and combinations thereof.

10. A method for the production of fiber composite materials, wherein one inner surface of a mold is lined with an adhesive film produced as claimed in claim 1, a composite material is produced on the lined inner surface of the fiber composite material, and the produced fiber composite material is detached from the masked inner surface of the mold.
